(19) United States
(12) Patent Application Publication
(10) Pub. No.: US 2019/0158956 A1
(43) Pub. Date: May 23, 2019

(54) METHOD FOR ENHANCING SOUND VOLUME AND SYSTEM FOR ENHANCING SOUND VOLUME

(71) Applicants: INVENTEC (PUDONG) TECHNOLOGY CORPORATION, Shanghai City (CN); INVENTEC CORPORATION, Taipei City (TW)

(72) Inventors: Yi-Lun CHENG, Taipei City (TW); Chih-Kai YANG, Taipei City (TW); Kuo-Chi TING, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/867,595

(22) Filed: Jan. 10, 2018

(30) Foreign Application Priority Data
Nov. 20, 2017 (CN) 201711155714.X

(51) Int. Cl. H04R 3/04

(52) U.S. Cl. CPC H04R 3/04; H04R 2430/01

(57) ABSTRACT

A method for enhancing sound volume includes the following steps: delivering a sound-source signal comprising a low-frequency signal to a processor by a set of sound-source equipment; generating a sound-enhancing signal by the processor according to the low-frequency signal within a delay period; and outputting an enhanced sound source signal comprising the low-frequency signal and the sound-enhancing signal to a speaker by the processor; wherein a waveform of the sound-enhancing signal is identical to a waveform of the low-frequency signal, and the delay period causes a phase difference between the sound-enhancing signal and the low-frequency signal.

### CROSS-REFERENCE TO RELATED APPLICATIONS

This non-provisional application claims priority under 35 U.S.C. § 119(a) on Patent Application No(s). 106140821 filed in China on Nov. 23, 2017, the entire contents of which are hereby incorporated by reference.

### TECHNICAL FIELD

The disclosure relates to a method of enhancing sound volume and a system of enhancing sound volume, more particularly to a method of enhancing sound volume and a system of enhancing sound volume for low-frequency signals.

### BACKGROUND

In general, most of electronic devices are equipped with speakers for broadcasting to listeners. However, the speakers installed in electronic devices have problems of broadcasting low-frequency sound signals lacking enough volume, and these problems are not overcome efficiently. Moreover, with the development of technology, the size of electronic devices in the market tends to be miniaturized in order to pursue the lightweight and portability. For example, manufacturers expect that the thickness of laptops can be reduced as much as they can in order to meet market expectations.

However, the available space within the laptops decreases when the thickness of the laptops is reduced. As a result, the size of speakers disposed within the laptops needs to be reduced. In this case, the problem of low-frequency sound signal, lacking enough volume, emitted by the speakers will become more significant. Therefore, how to maintain/enhance low-frequency sound in limited spaces of electronic devices is an important issue in the art.

### SUMMARY

A method for enhancing sound volume and a system for enhancing sound volume are provided by the present disclosure. In the method and the system, one or more sound-enhancing signals are generated in an extremely short period of time so as to enhance low-frequency sound signal for listeners.

A method for enhancing sound volume is disclosed according one embodiment of the present disclosure. The method includes the following steps: delivering a sound-source signal comprising a low-frequency signal to a processor by a set of sound-source equipment; generating a sound-enhancing signal by the processor according to the low-frequency signal within a delay period; and outputting an enhanced sound source signal comprising the low-frequency signal and the sound-enhancing signal to a speaker by the processor; wherein a waveform of the sound-enhancing signal is identical to a waveform of the low-frequency signal, and the delay period causes a phase difference between the sound-enhancing signal and the low-frequency signal.

A system for enhancing sound volume is disclosed according one embodiment of the present disclosure. The system includes a set of sound-source equipment and a processor. The set of sound-source equipment is configured to deliver a sound-source signal comprising a low-frequency signal. The processor is electrically connected to the set of sound-source equipment and configured to generate a sound-enhancing signal according to the low-frequency signal within a delay period and the processor is further configured to output an enhanced sound source signal comprising the low-frequency signal and the sound-enhancing signal to a speaker. A waveform of the sound-enhancing signal is identical to a waveform of the low-frequency signal, and the delay period causes a phase difference between the sound-enhancing signal and the low-frequency signal.

Based on the above description, in the method and the system for enhancing sound volume of the present disclosure, one or more sound-enhancing signals having waveforms identical to the low-frequency signal of the sound-source signal are generated by the processor in an extremely short period of time, so as to increase the sound pressure at a low-frequency. Therefore, the problem that low-frequency sound signals lack enough volume is improved in condition of limited space of electronic devices, so that listeners obtain low-frequency sound signals with enough volume.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a system for enhancing sound volume according to one embodiment of the present disclosure;

FIG. 2A is a diagram of waveforms of sound-enhancing signals according to one embodiment of the present disclosure;

FIG. 2B is a diagram of waveforms corresponding to partial area A of the sound-enhancing signals according to the embodiment of FIG. 2A;

FIG. 3 is a diagram of waveform of sound enhancement at a single frequency according to one embodiment of the present disclosure;

FIG. 4 is a diagram of waveform of an ideal sound enhancement according to one embodiment of the present disclosure; and

FIG. 5 is a diagram of flow chart illustrating a method for enhancing sound volume according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

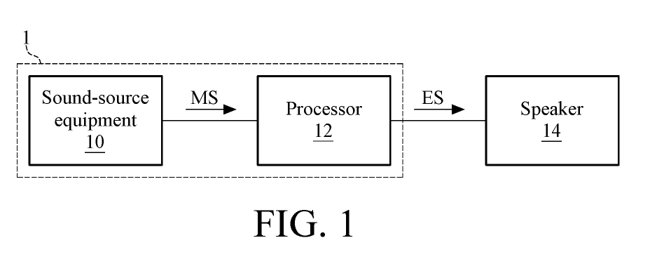

Please refer to FIG. 1, which is a block diagram of a system for enhancing sound volume according to one embodiment of the present disclosure. As shown in FIG. 1, a system for enhancing sound volume 1 includes a set of sound-source equipment 10 and a processor 12. The processor 12 is electrically connected to the set of sound-source equipment 10 and a speaker 14. The set of sound-source equipment 10 is configured to release a sound-source signal MS and deliver the sound-source signal MS to the processor 12. The sound-source signal MS includes a low-frequency signal. In practice, the set of sound-source equipment 10 may be a built-in CD/MP3 player of computers or other devices capable of broadcasting sounds, and the speaker 14 may be a built-in speaker of a computer. The sound-source signal MS may include one or more high-frequency signals in addition to one or more low-frequency signals. For example, the sound-source signal MS may be a song generated by a music player, and the described one or more low-frequency signals and one or more high-frequency signals respectively indicate low pitch and high pitch of the song.

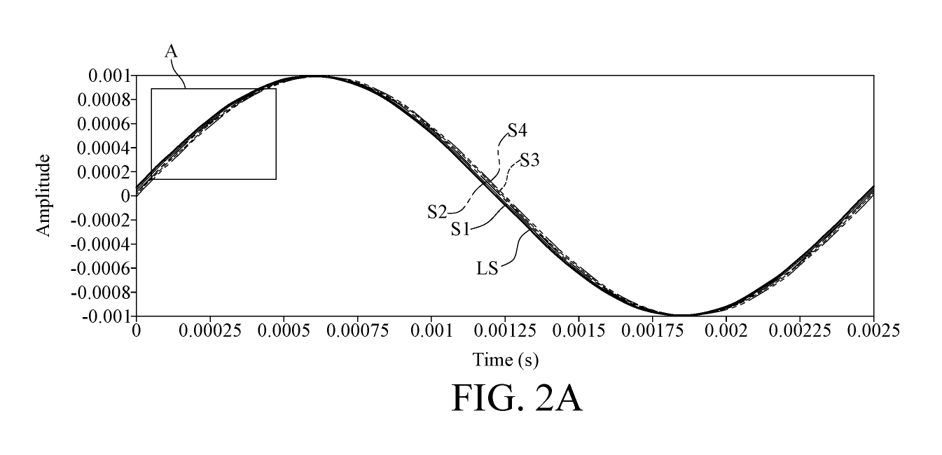

Please refer to FIG. 2A and FIG. 2B. FIG. 2A is a diagram of waveforms of sound-enhancing signals according to one embodiment of the present disclosure. FIG. 2B is a diagram of waveforms corresponding to partial area A of the sound-enhancing signals according to the embodiment of FIG. 2A. When the processor 12 receives the sound-source signal MS from a set of sound-source equipment 10, the processor 12 generates one or more sound-enhancing signals within a delay period according to the low-frequency signal of the sound-source signal MS, namely the low-frequency signal LS as well as the sound-enhancing signals S1-S4 generated in the delay period T shown in FIG. 2A and FIG. 2B. Then, the processor 12 further outputs an enhanced sound-source signal ES including the low-frequency signal LS and the sound-enhancing signals S1-S4 to the speaker 14. More specifically, the processor 12 generates the sound-source signal ES by composing the low-frequency signal LS and the sound-enhancing signals S1-S4 so as to output the sound-source signal ES to the speaker 14. As shown in FIG. 2A and FIG. 2B, the waveforms of the sound-enhancing signals S1-S4 are the same as the waveform of the low-frequency signal LS, and a phase difference exists between each of the sound-enhancing signals S1-S4 and the low-frequency signal LS. The phase differences existing between the sound-enhancing signals S1-S4 and the low-frequency signal LS are different from each other. It is noted that the system for enhancing sound volume of the present disclosure is designed for enhancing the relatively low frequency signals of the sound-source signal, such as a low frequency signal having frequency less than 500 Hz. For example, the low pitch of a song is enhanced using the system for enhancing sound volume.

In the embodiment of FIG. 2A and FIG. 2B as described above, the processor 12 generates a plurality of sound-enhancing signals within the delay period. Contrarily, in other embodiments, the processor 12 may generate a single sound-enhancing signal. The present is not limited to the number of sound-enhancing signals shown in the above embodiments. In practice, more sound-enhancing signals are generated in the delay period, the better the enhancement of sound is. Persons having ordinary skills in the art may adjust the setting of the processor 12 according to actual demands so as to generate a proper number of sound-enhancing signals. In an example, the processor 12 generates one or more sound-enhancing signals according to the low-frequency signal of the sound-source signal MS using technique of Active Noise Cancellation (ANC). Therefore, Persons having ordinary skills in the art may design the circuit of the processor 12 shown in FIG. 1 based on the well-known technique of ANC, so the circuit of the processor 12 is not introduced in detailed herein. In practice, when the processor 12 receives the low-frequency signal included in the sound-source signal MS, the processor 12 may generate one or more sound-enhancing signals using the computation of ANC technique. During the process of computation, a phase difference is generated between each of the one or more sound-enhancing signals and low-frequency signal LS due to the delay period caused by the computation of ANC technique implemented by the processor 12.

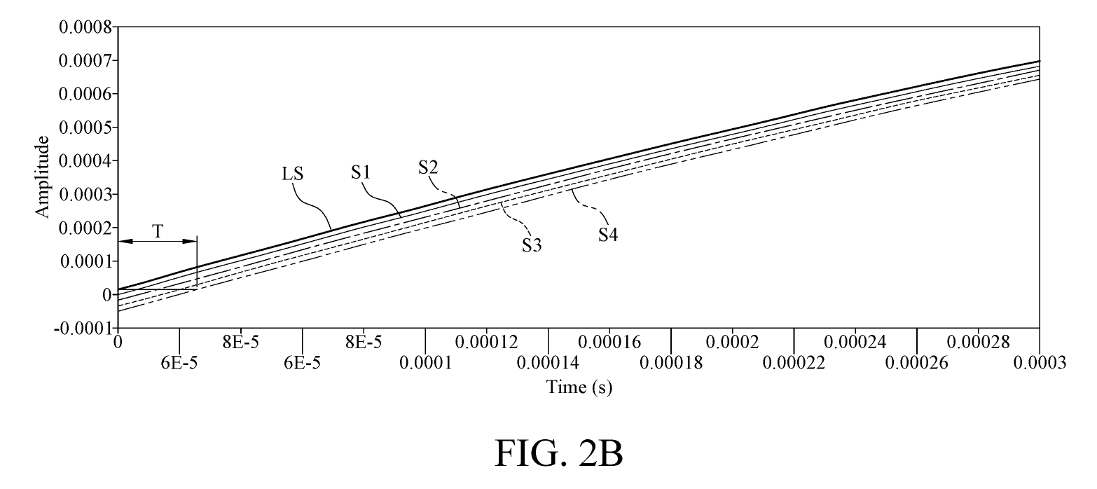

Please further refer to FIG. 3, which is a diagram of waveform of sound enhancement at a single frequency according to one embodiment of the present disclosure. As shown in FIG. 3, the sound pressure V1 of the sound-source signal MS delivered by the set of sound-source equipment 10 at frequency f (e.g. the described low-frequency signal) is approximately 31.73 (dB). When the processor 12 generates a sound-source signal ES by composing the low-frequency signal LS of the sound-source signal MS and the sound-enhancing signals S1-S4, the sound pressure V2 of the sound-source signal ES at frequency f is approximately 43.42 (dB). The speaker 14 broadcasts the sound-source signal to listeners. In other words, the system for enhancing sound volume of the present disclosure, the low-frequency signal LS and the one or more sound-enhancing signals are composed so as to convert the relatively low sound pressure of the sound source signal MS at the frequency of the low-frequency signal LS to the relatively high sound pressure of the enhanced sound-source signal ES at the frequency of the low-frequency signal LS for the listeners. As shown in FIG. 3, the sound pressure is raised from 31.73 dB to 43.42 dB. Therefore, the listeners still enjoy a better experience of a low-frequency sound even though electronic devices have limited internal space.

In one embodiment, the processor 12 generates a plurality of sound-enhancing signals S1-S4 in a short delay period (e.g. 10-30 μs). For example, as indicated by the diagram of waveforms corresponding to partial area A of the sound-enhancing signals shown in FIG. 2B, these sound-enhancing signals S1-S4 are generated within a delay period of 30 μs. In the aforementioned embodiment, the processor 12 needs to generate a plurality of sound-enhancing signals S1-S4 in an extremely short period of time so as to compose these sound-enhancing signals S1-S4 and the low-frequency signal LS. Therefore, the sound of the sound-source signal ES remains consistent to the listeners. In other words, even through a plurality of sound signal, with waveforms identical to each other and phases different from each other, are generated in the delay period, those sound signals received is still considered as a single sound by the listeners since the delay period is extremely short.

In an example, the frequency of the aforementioned low-frequency signal is less than 500 Hz. In other words, in this example, when the processor 12 receives the sound-source signal MS from the set of sound-source equipment 10, the processor 12 generates the one or more sound-enhancing signals only according to the low-frequency signal having the frequency less than 500 Hz. The purpose that the low-frequency signal is limited to be less than 500 Hz is that, since the wavelength of low-frequency signal less than 500 Hz is large, the sound provided to listeners remains consistent as the processor 12 generates sound-enhancing signals having different phases, so as to provide a better quality of sound enhancement. The frequency of the low-frequency signal mentioned in the above embodiment is used for illustration only, and the present disclosure is not limited to the embodiment described above. In fact, in other embodiments, the frequency of the low-frequency signal may be 1000 Hz or 2000 Hz.

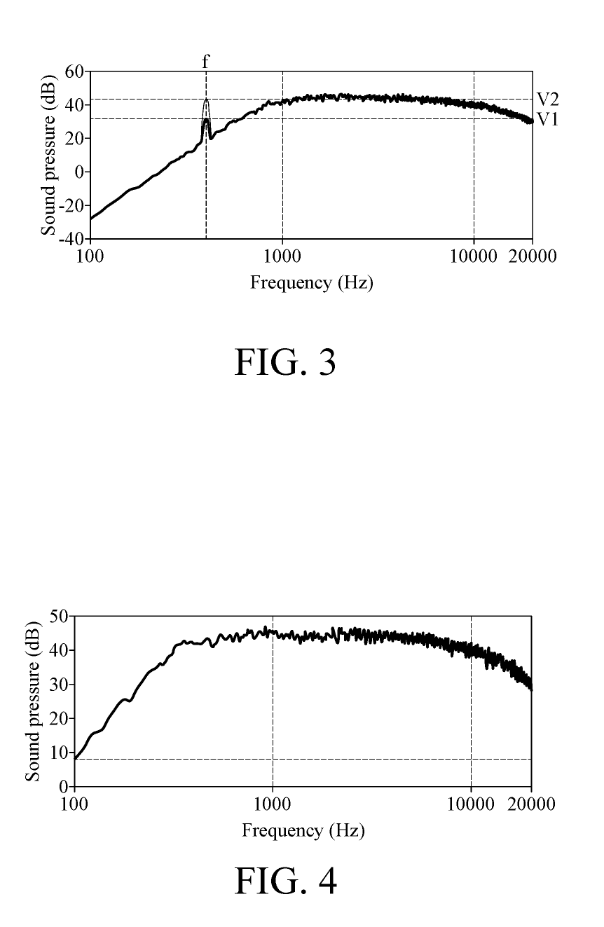

The embodiment of FIG. 3 described above illustrates the diagram of waveform of sound enhancement at a single frequency. Please further refer to FIG. 4, which is a diagram of waveform of an ideal sound enhancement according to one embodiment of the present disclosure. As shown in FIG. 4, ideally, the processor 12 generates a plurality of sound-enhancing signals having different phases according to a plurality of low-frequency signals (e.g. signal with frequency less than 1000 Hz) included in the sound-source signals MS respectively. Thereby, the relative low sound pressure of the low-frequency signals included in the sound-source signal MS are converted to a relative high sound pressure of an enhanced sound-source signal and then the enhanced sound-source signal is provided to listeners through the speaker 14. Thus, the problem that low-frequency signals lack enough volume is improved significantly.

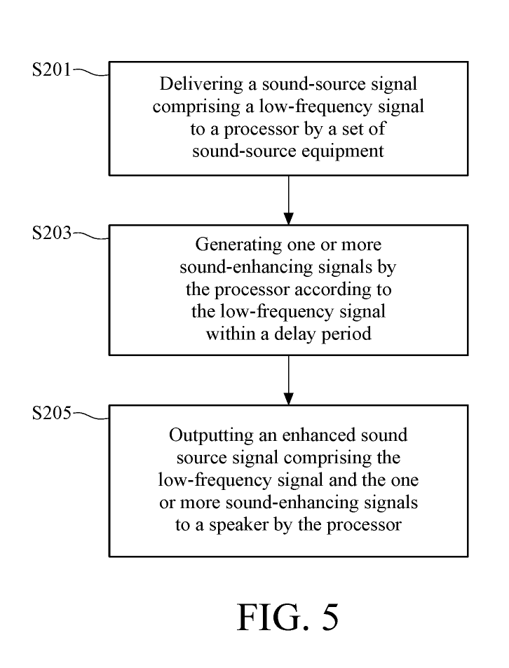

Please refer to FIG. 1 and FIG. 5. FIG. 5 is a diagram of flow chart illustrating a method for enhancing sound volume according to one embodiment of the present disclosure. As shown in FIG. 5, in the method for enhancing sound volume of one embodiment of the present disclosure, in step S201, the sound-source signal MS including a low-frequency signal is delivered to the processor 12 by the set of sound-source equipment 10. In step S203, one or more sound-enhancing signals are generated by the processor 12 according to a low-frequency signal of the sound-source signal MS in a delay period. In step S205, the sound-source signal ES, including the low-frequency signal and the one or more sound-enhancing signals, is outputted to the speaker 14 by the processor 12. In one embodiment, the aforementioned delay period is the range of 10-30 μs, but the present disclosure is not limited to the embodiments described above.

In one embodiment, in addition to the aforementioned one or more sound-enhancing signals, the processor 12 may further generate other sound-enhancing signals. Each of those sound-enhancing signals has a waveform identical to the waveform of the low-frequency signal, and the phase differences between those sound-enhancing signals and the low-frequency signal are different from each other. As shown in FIG. 2A and FIG. 2B, the phase differences between the sound-enhancing signals S1-S4 and the low-frequency signal LS are different from each other. In a preferred embodiment, the frequency of the low-frequency signal is less than 500 Hz, but the present disclosure is not limited to the preferred embodiment. In an example, the sound-source signal ES generated by composing has a first sound pressure, and the low-frequency signal LS has a second sound pressure. The first sound pressure is greater than the second sound pressure. In practice, the more sound-enhancing signals are generated by the processor 12 in the delay period, the more significant the difference between the first sound signal and the second sound signal is. As shown in FIG. 3, the difference between the sound pressure V1 and the sound pressure V2 is approximately 12 dB as four sound-enhancing signals S1-S4 are generated.

Based on the above description, in the method and the system for enhancing sound volume of the present disclosure, one or more sound-enhancing signals having waveforms identical to the low-frequency signal of the sound-source signal are generated by the processor in an extremely short period of time, so as to increase the sound pressure at a low-frequency. Therefore, the problem that low-frequency sound signals lack enough volume is improved in condition of limited space of electronic devices, so that listeners obtain low-frequency sound signals with enough volume.

What is claimed is:

1. A method for enhancing sound volume, comprising:
delivering a sound-source signal comprising a low-frequency signal to a processor by a set of sound-source equipment;
generating a sound-enhancing signal by the processor according to the low-frequency signal within a delay period; and
outputting an enhanced sound source signal comprising the low-frequency signal and the sound-enhancing signal to a speaker by the processor;
wherein a waveform of the sound-enhancing signal is identical to a waveform of the low-frequency signal, and the delay period causes a phase difference between the sound-enhancing signal and the low-frequency signal.

2. The method for enhancing sound volume according to claim 1, wherein the sound-enhancing signal is defined as a first sound-enhancing signal, the processor further generates a second sound-enhancing signal according to the low-frequency signal, a waveform of the second sound-enhancing signal is identical to the waveform of the low-frequency signal, and a phase difference between the second sound-enhancing signal and the low-frequency signal is different from the phase difference between the first sound-enhancing signal and the low-frequency signal.

3. The method for enhancing sound volume according to claim 1, wherein a frequency of the low-frequency signal is less than 500 Hz.

4. The method for enhancing sound volume according to claim 1, wherein the delay period is 10-30 μs.

5. The method for enhancing sound volume according to claim 1, wherein the enhanced sound source signal has a first sound pressure, the low-frequency signal has a second sound pressure, and the first sound pressure is greater than the second sound pressure.

6. A system for enhancing sound volume, comprising:
a set of sound-source equipment configured to deliver a sound-source signal comprising a low-frequency signal;
a processor electrically connected to the set of sound-source equipment and configured to generate a sound-enhancing signal according to the low-frequency signal within a delay period and the processor further configured to output an enhanced sound source signal comprising the low-frequency signal and the sound-enhancing signal to a speaker;
wherein a waveform of the sound-enhancing signal is identical to a waveform of the low-frequency signal, and the delay period causes a phase difference between the sound-enhancing signal and the low-frequency signal.

7. The system for enhancing sound volume according to claim 6, wherein the sound-enhancing signal is defined as a first sound-enhancing signal, the processor further generates a second sound-enhancing signal according to the low-frequency signal, a waveform of the second sound-enhancing signal is identical to the waveform of the low-frequency signal, and a phase difference between the second sound-enhancing signal and the low-frequency signal is different from the phase difference between the first sound-enhancing signal and the low-frequency signal.

8. The system for enhancing sound volume according to claim 6, wherein a frequency of the low-frequency signal is less than 500 Hz.

9. The system for enhancing sound volume according to claim 6, wherein the delay period is 10-30 μs.

10. The system for enhancing sound volume according to claim 6, wherein the enhanced sound source signal has a first sound pressure, the low-frequency signal has a second sound pressure, and the first sound pressure is greater than the second sound pressure.
